(19) United States
(12) Patent Application Publication
(10) Pub. No.: US 2025/0187484 A1
(43) Pub. Date: Jun. 12, 2025

(54) Adapting an Item of Property Information Relating to a Charging Process

(71) Applicant: Bayerische Motoren Werke Aktiengesellschaft, Muenchen (DE)

(72) Inventor: Richard WISBRUN, Ottobrunn (DE)

(21) Appl. No.: 18/686,060

(22) PCT Filed: Jul. 26, 2022
(86) PCT No.: PCT/EP2022/070936

§ 371 Date: Feb. 23, 2024

(30) Foreign Application Priority Data
Aug. 24, 2021 (DE) 10 2021 121 896.9

(51) Int. Cl. B60L 53/68; B60L 53/65; B60L 53/66

(52) U.S. Cl. CPC B60L 53/68; B60L 53/65; B60L 53/66; B60L 2240/62; B60L 2240/72; B60L 2260/50

(57) ABSTRACT

A method is provided for adapting at least one item of property information relating to a charging process at a charging station. At least one charging parameter relating to the charging process is reported from electric vehicles connected at this charging station to an external evaluation entity. The evaluation entity evaluates the at least one charging parameter, and the evaluation entity provides at least one item of property information determined from the evaluation to at least one entity that can be involved in a future charging process at this charging station.

### BACKGROUND AND SUMMARY

The invention relates to a method for adapting at least one item of property information relating to a charging process at a charging station. The invention can advantageously be applied, in particular, to public charging stations.

The ISO standard 15118 (“Plug & Charge”), in which charging processes of an electric vehicle at a public charging column are started or ended simply by connecting or disconnecting the charging cable when a communication protocol is supported by the components involved, is known. In this case, the use of a charging card, for example, for authorizing and paying for the charging process becomes superfluous.

It is also known to enable a charging current of a charging column by way of a smartphone application. For this purpose, the app or the selected charging column can have a start/stop function which instructs a control entity of the charging column to start or to end a charging process.

It is furthermore known that users of electric vehicles can report faulty public charging columns to their operators, for example via a corresponding website. However, it may be inconvenient for a user of an electric vehicle who wishes to charge the electric vehicle at a charging column, for example due to incorrect or inaccurate entries in a database when setting up the charging column and/or due to component-related or design-related deviations in the charging behavior of a charging column from manufacturer specifications. For example, the geoposition of the charging column may correspond to the geoposition indicated in a route planner only inaccurately, which makes it difficult for a user to locate the charging column. A charging column may also possibly react only with a long delay to a charging current release/charging start requested by a user of an electric vehicle, as a result of which the user possibly incorrectly assumes that the activation or start of the charging process at this charging column has failed. If the user then attempts to reactivate this charging column for charging, although they are still attempting to initiate the previous activation, it may be that the operation of this charging column is suppressed for a particular period of time since some charging columns have mechanisms that suppress simultaneous activation or activation processes in quick succession, in particular via online connections. The user therefore often feels obliged to connect their electric vehicle to another charging column, which may be associated with having to repark, which is inconvenient.

WO 2013/053394 A1 discloses a method and a device for determining a position of a charging station, wherein mobility events of at least one mobile telephone are identified in order to determine the position.

The object of the present invention is to overcome the disadvantages of the prior art at least partly and, in particular, to provide an option for adapting or correcting current property information relating to a charging process at a charging station.

This object is achieved according to the features of the claimed invention.

The object is achieved by way of a method for adapting at least one item of property information relating to a charging process at a charging station, wherein:

at least one charging parameter (referred to in the following text as “charging parameter” without restricting the generality) relating to the charging process is reported from electric vehicles connected at this charging station (and thus charging or to be charged) to an external evaluation entity;
the evaluation entity evaluates the at least one charging parameter; and
the evaluation entity provides at least one item of property information determined from the evaluation to at least one entity that can be involved in a future charging process at this charging station.

This method produces the advantage that an item of property information relating to a current and/or future charging process can be reliably checked statistically and, where necessary, corrected by evaluating the (historic) charging parameters of a plurality of electric vehicles. As a result, the implementation of charging processes is made easier in turn, in particular the probability that expectations of users of electric vehicles with respect to simple implementation of charging processes at this charging column are belied is reduced, which in turn increases user satisfaction. The method thus provides the opportunity to compile a “fleet learning curve” relating to properties of each charging station used by of a plurality of electric vehicles of a fleet by evaluating charging parameters of the group or fleet of electric vehicles, in particular of a particular manufacturer.

An item of property information relating to a charging process at a charging station can be understood to mean, in particular, any retrievable item of information about a property of the charging station that influences a charging process.

The adaptation of the item of property information may comprise correcting or more accurately specifying the item of information.

The external evaluation entity may be, for example, a backend of a manufacturer of electric vehicles.

The reporting may comprise, for example, transmission of the at least one charging parameter, for example via radio.

The fact that the evaluation entity evaluates the at least one charging parameter comprises, in particular, the fact that it determines or calculates at least one item of property information from at least one reported charging parameter and possibly at least one further parameter. Therefore, the at least one charging parameter corresponds to an input variable of the evaluation and the at least one item of the information corresponds to a result of the evaluation. One development is that an item of property information corresponds to the charging parameter, that is to say the item of property information and charging parameter represent the same variable but may differ in terms of value. One development is that an item of property information does not correspond to any of the charging parameters.

The fact that the evaluation entity provides at least one item of property information identified from the evaluation to at least one entity that can be involved in a future charging process at this charging station comprises the fact that the now possibly adapted or corrected item of property information can be provided to that entity that may be involved or included in a future charging process at this charging station.

The item of property information identified may for this purpose be stored, for example, in a retrievable database and/or be actively transmitted to an entity that can be involved.

The charging parameter may comprise, for example, charging properties of the charging column and/or of an electric vehicle charging or to be charged at the charging column. As an alternative or in addition, the charging parameter may comprise geometric variables relating to the charging process.

One configuration is that the at least one charging parameter comprises at least one parameter from the group of:
(geo) position of an electric vehicle connected to the charging station;
orientation of an electric vehicle connected to the charging station;
length of a charging cable of the electric vehicle or the charging station;
identifier of the charging station (in the following text referred to as “station identifier” without restricting the generality) to which the electric vehicle is connected;
identifier of the electric vehicle;
success or failure (for example lack of activation, termination) of the charging process; and
charging behavior of the charging station.

The geometric variable “geoposition” of the electric vehicle to be charged may be determined, for example, by GPS, WLAN or other geopositioning methods. The geometric variable “orientation” of the electric vehicle to be charged, in particular the angle of the longitudinal direction thereof in relation to the charging station, may be determined, for example, by travel data and/or evaluation of images captured by the electric vehicle. The geometric variable “length of a charging cable” may comprise the length of a charging cable of the electric vehicle, which is advantageous, in particular, when the charging cable of the electric vehicle is used for connection to the charging station.

The length of the charging cable may be reported directly from the electric vehicle or derived from the type of electric vehicle, for example from the VIN—which in particular is also reported. However, it is also possible that a user has previously entered the length of the charging cable in a data memory, or the vehicle has identified the length by way of a measurement after the charging cable has been plugged into the charging socket on the vehicle.

If the charging station has a charging cable with a known length, this may also be derived, for example, via the station identifier. The station identifier may be received by the electric vehicle, for example, by way of data exchange between the charging station and the electric vehicle.

The charging behavior of the charging station may comprise one or more charging parameters, for example a period of time between a user requesting a charging activation and the charging activation actually occurring. The identifier of the electric vehicle, for example the VIN thereof, may also be used to evaluate whether particular items of property information are dependent on the electric vehicle type. It may thus be that a particular charging station is experiencing problems only in relation to particular electric vehicle types, for example of the same electrical infrastructure generation.

The electric vehicle may be, for example, a plug-in hybrid vehicle or a fully electrically driven vehicle.

One configuration is that the at least one entity that can be involved comprises:
an electric vehicle with a charging request at the charging station;
a control entity for activating the charging station (for example an operator of the charging station); and/or
an operator of a route planner comprising the charging station, for example as a point of interest.

The electric vehicle with a charging request may have selected a particular charging station for a future charging process along the route, for example during route planning. As an alternative or in addition, the electric vehicle with a charging request may be an electric vehicle that is currently connected to the charging station. The control entity for activating the charging station may be, for example, a control device of the operator of the charging station. An electric vehicle may, for example, use the route planner, where the map indicates at least positions of the charging stations shown on the map, possibly even other items of information such as a charging characteristic of the charging station, for example plug types, charging power, available payment methods, etc.

One configuration is that at least the geoposition of the electric vehicle connected to the charging station and the station identifier are reported to the external evaluation entity and the evaluation entity evaluates the geoposition and the station identifier by
determining, at least based on the geoposition of the electric vehicle and the length of the charging cable used as the charging parameters, an area within which the associated charging station is probably located,
checking whether a predetermined geoposition of the charging station is within the area, and
if this is not the case at least once, determining from the areas of several electric vehicles that have been charged at this charging station a probable position of the charging station as identified property information and thus correcting, for example replacing, the previous position of the charging station.

This achieves the advantage that a position of the charging station (as the item of property information) that has previously been specified, possibly erroneously or very inaccurately, may be corrected so that a user of an electric vehicle can better locate this charging station. The inaccuracy in the specified position may have been brought about, for example, by the position of the charging station (for example transposed digits, etc.) being manually input correctly or by purely inaccurate geolocation of the charging station when the charging station is set up. This previous position is thus adapted or corrected.

One development is that the geoposition of the electric vehicle connected to the charging station and the station identifier are reported. The length of the charging cable of the electric vehicle may also be reported or determined from the type of electric vehicle. If the charging station has a fixedly attached charging cable, the length thereof may be reported after data exchange with the electric vehicle or derived from the station identifier.

These charging parameters are used to determine an area within which the associated charging station should or ought to be located, since the geoposition of the electric vehicle and the length of the charging cable are used to clearly localize the possible positions of the charging station, possibly with some systematic uncertainties such as the position accuracy of the electric vehicle, possibly inaccurate knowledge about the position of the charging socket of the electric vehicle, etc.

If the charging station is not located within this area and this is determined for one or more charging processes, a probable position of the charging station as the identified property information is determined from the areas of several electric vehicles that have been charging at this charging station and is assumed instead of the previous specified or known or stored position of the charging station.

One development is that the probable (new) position of the charging station is calculated from a geometric overlaying of areas determined for several electric vehicles, for example as a geometric center of the overlay region or the overlay regions that is or are overlaid by most of the individual areas.

One configuration is that the area is a circular area, the radius of which corresponds to a length of the charging cable of the electric vehicle or the charging station. Such area determination may be carried out particularly easily.

One configuration is that the center of the circular area corresponds to a position of a charging socket of the electric vehicle. As a result, the area may be determined even more precisely.

One development is that the area is determined depending on an alignment of the electric vehicle. The area may thus also be determined even more precisely. Therefore, for example with high electric vehicles such as SUVs or buses, the area adopted may be only a semicircle that extends in front of the electric vehicle starting from the charging socket when it is assumed that the charging cable is not led over the electric vehicle. As an alternative or in addition, the position of the charging socket can be determined more accurately with knowledge of the orientation of the electric vehicle.

One configuration is that the evaluation entity provides the probable position of the charging station to an electric vehicle with a charging request at this charging station and/or an operator of a route planner comprising the charging station as a point of interest or the like as the entities that can be involved.

One configuration is that at least one charging parameter relating to the charging behavior of the charging station is reported to the evaluation entity; the evaluation entity statistically evaluates this at least one charging parameter for the purpose of evaluation and classifies the result of the statistical evaluation; and the evaluation entity provides the result of the classification as property information of the at least one entity that can be involved. This achieves the advantage that, for example, target or standard property information based on manufacturer details may be checked and where necessary corrected through actual operation of electric vehicles. In this case, the set of electric vehicles is utilized to obtain the statistical validation of an item (or items) of property information calculated therefrom.

The classification is used to evaluate the property information determined from the statistical population of charging parameters on the basis thereof, for example to confirm, to reject, to refine or to correct the previous property information. For example, the charging station may be classified as “suitable” or “unsuitable” for particular types of electric vehicle, etc.

One configuration is that the at least one charging parameter relating to the charging behavior of the charging station comprises a temporal behavior of the charging station between a charging activation requested by a user of an electric vehicle at the charging station until the charging station is activated and the evaluation entity provides the result of the classification to at least one control entity in order to activate the charging station. Therefore, for example, a period of time between requesting and activating a charging station may be classified as within a target period of time or as “unusually long-lasting”. If, for example, longer switching times arise when not all of the plugs can be opened at the same time, the switching times can be detected statistically and taken into account when actuating the specific charging station. The control entity may then use a particularly expedient actuation procedure in order to begin the charging process as quickly as possible.

One configuration is that the charging station is a public charging station. One development is that the charging station is an AC charging station.

If there are signs of a change to the components installed in the charging column, which suggest a change in behavior during operation, the relevant classifications can be checked until the next charging process has been carried out by a vehicle.

The above-described properties, features and advantages of this invention and the way in which these are achieved will become clearer and more clearly comprehensible in connection with the following schematic description of one exemplary embodiment, which is explained in more detail in connection with the drawing.

### BRIEF DESCRIPTION OF THE DRAWING

FIG. 1 shows a fleet of electric vehicles that are connected to a public AC charging column.

### DETAILED DESCRIPTION OF THE DRAWING

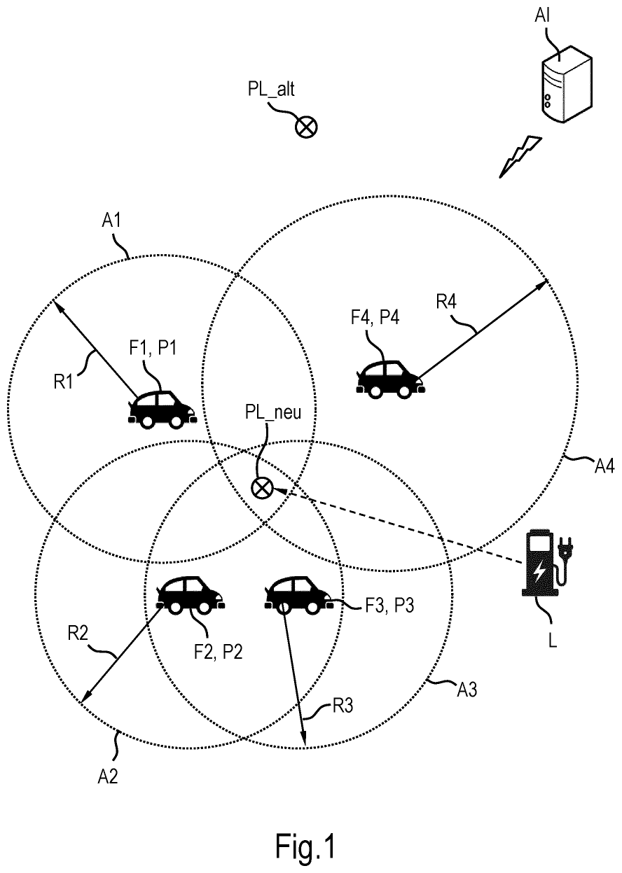

FIG. 1 shows a drawing of electric vehicles F1 to F4 that have been connected to a public AC charging column L in chronological succession at respective positions P1 to P4 for charging. The geoposition PL_alt of the charging column L has been entered into a database (top of the figure) when it was set up and corresponds only inaccurately to the actual position thereof, for example due to the transposed digits of a person doing the entering. Route planners use the database to identify charging columns and can travel toward them as destinations. The charging column L is therefore located in route planners only very inaccurately/incorrectly at first and therefore can be located by users of electric vehicles only with difficulty or even purely through luck.

A fleet operator of a fleet of electric vehicles F1 to F4 may also be present, for example a vehicle manufacturer who is able to exchange data with the electric vehicles F1 to F4, in particular able to receive data from the electric vehicles F1 to F4, for example their position, vehicle identifier (for example VIN), the fact that they are connected to a charging station, a station identifier received from the charging column L, etc. The fleet operator also serves here as the evaluation entity AI.

Therefore, for example, if the electric vehicle F1 is to be charged and if the user/driver has luckily found the charging column L at its actual position, the user plugs the charging cable they have carried with them to the charging column L in order to charge the vehicle. In this case, it is assumed here, for example, that the charging column L does not have its own charging cable fixedly installed thereon. The parked electric vehicle F1 subsequently reports at least its geoposition P1, its VIN and the station identifier of the charging column L as charging parameters to the evaluation entity AI, for example by way of a radio message. In one variant, the length of the charging cable of the electric vehicle F1 can also be reported. As an alternative, the evaluation entity AI can take the length from typical vehicle cable lengths.

The evaluation entity AI then checks whether the currently stored geoposition PL_alt of the charging column L corresponding to the station identifier is located within a circular area Al, the center of which corresponds to the position P1 of the vehicle F1, in particular the charging socket thereof, and the radius R1 of which corresponds to the length of the connected charging cable.

If this is not the case, as illustrated here, the evaluation entity AI waits to see whether another second vehicle F2 is connected to this charging column L later. If this is the case, the evaluation entity AI checks whether the currently stored geoposition PL_alt of the charging column L is within an area A2 around the vehicle F2 (for example around a position of the charging socket thereof), the radius R2 of which corresponds to the length of the charging cable of the vehicle F2. If this is not the case for vehicle F2 either, the evaluation entity AI determines the geometric center of the intersection of areas A1 and A2 as the information and stores this as a new geoposition PL_neu. The new geoposition PL_neu may be reported further, for example, to electric vehicles of the fleet of the fleet operator and/or operators of route planners, etc.

In one variant, the geoposition PL_neu of the charging column L may be determined more accurately with each connected vehicle F3, F4, etc. by this being calculated as the geometric center of the intersection of most of the areas A1, A2, A3, A4, etc. This is illustrated here for vehicles F1 to F4, where the intersection for all four areas A1 to A4 corresponds to the solid line running directly around the geoposition PL_neu.

Of course, the present invention is not restricted to the exemplary embodiment shown above.

Generally speaking, “a”, “an”, “one” etc. may be understood to mean a single number or a plurality, in particular in the sense of “at least one” or “one or more”, provided that this is not explicitly ruled out, for example by the expression “exactly one”, etc.

A numerical specification may also comprise precisely the specified number and a conventional tolerance range, provided that this is not explicitly ruled out.

### LIST OF REFERENCE SIGNS

AI Evaluation entity
A1-A4 Areas
F1-F4 Electric vehicles
L Charging column
P1-P4 Position
PL_alt Previous geoposition of the charging column
PL_neu New geoposition of the charging column
R1-R4 Length of a charging cable

1.-10. (Canceled)

11. A method for adapting at least one item of property information relating to a charging process at a charging station, the method comprising:
reporting at least one charging parameter relating to the charging process from electric vehicles connected at the charging station to an external evaluation entity;
evaluating, by the evaluation entity, the at least one charging parameter; and
providing, by the evaluation entity, the at least one item of property information determined from the evaluating to at least one entity that is involvable in a future charging process at the charging station.

12. The method according to claim 11, wherein the at least one charging parameter comprises at least one parameter selected from the group consisting of:
geoposition of an electric vehicle connected to the charging station;
orientation of the electric vehicle connected to the charging station;
length of a charging cable of the electric vehicle or the charging station;
identifier of the charging station to which the electric vehicle is connected;
success of the charging process; and
charging behavior of the charging station.

13. The method according to claim 11, wherein the at least one entity that is involvable comprises at least one of:
an electric vehicle with a charging request at the charging station;
a control entity for activating the charging station; or
an operator of a route planner comprising the charging station.

14. The method according to claim 12, wherein:
at least the geoposition of the electric vehicle connected to the charging station and the station identifier are reported to the external evaluation entity; and
the evaluation entity evaluates the geoposition and the station identifier by:
determining, at least based on the geoposition of the electric vehicle and a length of the charging cable used, an area within which the associated charging station is probably located,
checking whether a predetermined geoposition of the charging station is within the area, and
upon determining that the predetermined geoposition of the charging station is not within the area at least once, determining from areas of several electric vehicles that have been charged at the charging station a probable position of the charging station as identified property information and thus correcting the predetermined position of the charging station.

15. The method according to claim 14, wherein the area is a circular area, a radius of which corresponds to a length of the charging cable of the electric vehicle or the charging station.

16. The method according to claim 15, wherein a center of the circular area corresponds to a position of a charging socket of the electric vehicle.

17. The method according to claim 14, wherein the evaluation entity provides the probable position of the charging station to at least one of an electric vehicle with a charging request at the charging station or an operator of a route planner comprising the charging station as the at least one entity that is involvable.

18. The method according to claim 12, wherein:
at least one charging parameter relating to the charging behavior of the charging station is reported to the evaluation entity;
the evaluation entity statistically evaluates the at least one charging parameter for relating to the charging behavior of the charging station evaluation and classifies a result of the evaluation; and
the evaluation entity provides a result of the classification as property information to the at least one entity that is involvable.

19. The method according to claim 18, wherein the at least one charging parameter relating to the charging behavior of the charging station comprises a temporal behavior of the charging station between an expressed charging request of a user for an electric vehicle at the user at the charging station until the charging station is activated and the evaluation entity provides the result of the classification to at least one control entity in order to activate the charging station.

20. The method according to claim 11, wherein the charging station is a public charging column.
